(19) United States
(12) Patent Application Publication
(10) Pub. No.: US 2018/0287223 A1
(43) Pub. Date: Oct. 4, 2018

(54) SAFETY STRUCTURE OF A BATTERY PACK

(71) Applicant: Bordrin Motor Corporation, Inc., Southfield, MI (US)

(72) Inventors: Chong Yok Meng, Singapore (SG); Haoxing Zhao, Shanghai (CN); Zhiwei Zhang, Shanghai (CN); Yonghua Li, Ann Arbor, MI (US); Tiepeng Zhao, Shanghai (CN)

(21) Appl. No.: 15/811,915

(22) Filed: Nov. 14, 2017

(30) Foreign Application Priority Data
Mar. 31, 2017 (CN) 201720333051.5

(51) Int. Cl. H01M 10/48; H01M 2/10; H01M 10/42

(52) U.S. Cl. CPC H01M 10/482; H01M 2/1077; H01M 2010/4278; H01M 2200/20; H01M 2220/20; H01M 10/425

(57) ABSTRACT

A power battery pack may include several pouch or hard-shelled electrochemical cells. A safety structure for the power battery pack may include an expansion absorption layer, a supporting and fixing tray, an upper module press plate, a lower module bottom plate, and the like. There are multiple supporting and fixing trays and multiple expansion absorption layers. The multiple supporting and fixing trays are sequentially disposed from top to bottom layer by layer. One single electrochemical cell is disposed in each of the supporting and fixing trays. One expansion absorption layer is laid on a top surface of each single electrochemical cell. The upper module press plate is disposed in a manner of covering the topmost supporting and fixing tray. The lower module bottom plate is disposed on a bottom surface of the bottommost supporting and fixing tray. A strain sensor is disposed in the center of a top surface of the topmost single electrochemical cell. The strain sensor is connected to a battery management system (BMS) control board.

### PRIORITY CLAIM

This application claims priority to Chinese Patent Application No. 201720333051.5, filed on Mar. 31, 2017, the contents of which is hereby incorporated by reference in its entirety.

### BACKGROUND

### 1. Field of the Invention

The present invention generally relates to a battery pack, and in particular, to a safety structure of a battery pack.

### 2. Description of Related Art

Safety of batteries (alternatively referred to as power batteries) plays a crucial role in the safety of electric vehicles. A power battery of an electric vehicle includes an electrochemical cell module, a battery management system (BMS), a maintenance switch, a relay, and a housing.

A basic energy carrier of a power battery is an electrochemical cell, and there are three commonly used shapes of an electrochemical cell: a pouch, a metal square housing, and a cylinder. In the three electrochemical cell designs that are widely used in power batteries, expansion of a pouch electrochemical cell or an electrochemical cell with a metal square housing may occur due to inner volume increase, especially at the center, as shown in FIG. 1. This expansion may be caused by electrochemical cell overcharging, electrochemical cell overheating, lithium metal deposition, side reaction increase, electrochemical cell aging, and the like.

An expansion status of an electrochemical cell is closely related to the heath status of the electrochemical cell. Monitoring the expansion status of the electrochemical cell can provide basic parameters for a BMS to monitor the health status of a power battery and to provide a warning if an issue is detected. Therefore, it is necessary to develop a safety structure of a power battery pack, to monitor an expansion status of an electrochemical cell.

FIG. 1 illustrates a prior art solution. As shown in FIG. 1, if a pressure sensor 11 is disposed on a contact surface between expanded electrochemical cells 10, expansion of the electrochemical cell 10 needs to be affected by an expansion absorption layer, a supporting and fixing tray, an upper module press plate, a lower module bottom plate, a module supporting member, and the like layer by layer, so that the pressure can be collected by the sensor 11. However, this solution has the drawback in that the error is relatively large in the sensitivity of the system is relatively low, thus not making the system particularly useful in detecting issues.

### SUMMARY

A safety structure of a power battery pack includes a plurality of rectangular single electrochemical cells. The safety structure includes an expansion absorption layer, a supporting and fixing tray, an upper module press plate, and a lower module bottom plate. There are multiple supporting and fixing trays and multiple expansion absorption layers. The quantity of single electrochemical cells may be greater than 1 and less than or equal to 30.

The multiple supporting and fixing trays are sequentially disposed from top to bottom layer by layer. One single electrochemical cell may be disposed in each of the supporting and fixing trays. One expansion absorption layer may be laid on a top surface of each single electrochemical cell. The upper module press plate may be disposed in a manner of covering the topmost supporting and fixing tray. The lower module bottom plate may be disposed on a bottom surface of the bottommost supporting and fixing tray. A strain sensor may be disposed in the center of a top surface of the topmost single electrochemical cell. The strain sensor may be in communication with a BMS control board. A strain signal is converted into expansion data and health status data of an electrochemical cell by using a mathematical model built in a BMS.

The safety structure further may include a module supporting member and may include multiple module supporting members. A supporting member through hole may be disposed on each of the supporting and fixing trays. A supporting member fixing hole may be disposed on each of the upper module press plate and the lower module bottom plate. Two ends of the module supporting member are respectively fixed in the supporting member fixing holes of the upper module press plate and the lower module bottom plate after the module supporting member passes through the supporting member through holes of the supporting and fixing trays. The stiffness of the lower module bottom plate may be greater than the stiffness of the upper module press plate and the stiffness of the supporting and fixing tray.

The expansion absorption layer may be an expansion absorption layer made of foamed silicone rubber. The strain sensor may be attached to the center of the top surface of the topmost single electrochemical cell. A surface of the strain sensor may be coated with a thermal insulation protection film. The strain sensor may be a resistive strain sensor.

The module uses a pouch electrochemical cell, or the supporting and fixing tray and the pouch electrochemical cell may be replaced with a hard-shelled electrochemical cell. The module safety structure is also effective when the module is side-mounted.

Compared with the prior art, the present utility model has at least the following advantages:

First, it is simple and direct to use a strain sensor to monitor an expansion status of an electrochemical cell.

Second, only one strain sensor is needed to monitor electrochemical cells superimposed in a module, and advantages of a simple design, low costs, convenient processing and use, and the like are presented.

Third, because a strain sensor is installed on an outermost end, a requirement on layout is low, and it is easy for implementation.

Fourth, an expansion rate of an electrochemical cell detected by using a strain sensor reflects a volume change and an inner pressure value in the electrochemical cell, so as to facilitate safety of subsequent monitoring of an electrochemical cell.

Fifth, a supporting and fixing tray cooperates with an upper module press plate, a lower module bottom plate, and a module supporting member, to form stable superimposition space of a single electrochemical cell. A quantity for superimposition may be randomly adjusted within 1 to 30, the structure is simple, and adaptability is strong.

Sixth, an expansion absorption layer made of foamed plastic is laid on top of a single electrochemical cell. The expansion absorption layer has certain elasticity, and can bear expansion and deformation of the single electrochemical cell within a certain range, further ensuring safety of a power battery.

Seventh, a surface of the strain sensor is coated with a thermal insulation protection film, so that long-time stable work of the strain sensor may be better ensured.

Eighth, a strain sensor may be a resistive strain sensor, which has low manufacturing costs, and is easy to implement.

Finally, the entire safety structure is simple and practical, and may be integrated into a structural member assembled in a battery. The assembly is quick, the safety structure is convenient to transport, and safety of a high-capacity power battery pack may be ensured.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic structural diagram showing that a prior art pressure sensor is disposed between electrochemical cells;

FIG. 2 is a schematic diagram of a safety structure of a power battery pack according to the present utility model;

FIG. 3 is a partial enlarged schematic diagram of a part A in FIG. 2;

FIG. 4 is a schematic diagram of an operating principle of the present utility model; and

FIG. 5 is a schematic diagram showing that a strain sensor on a hard-shelled electrochemical cell.

### DESCRIPTION

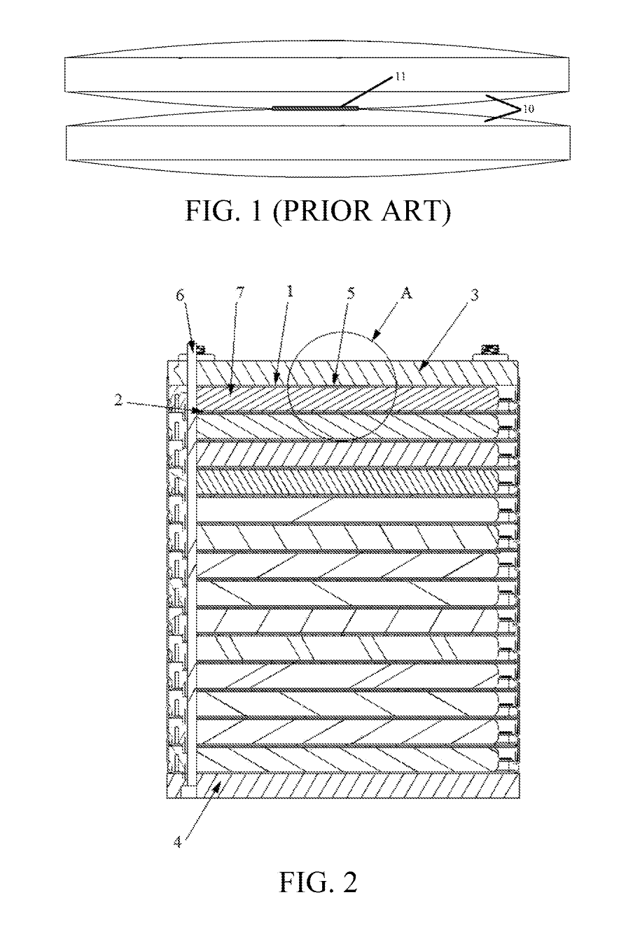

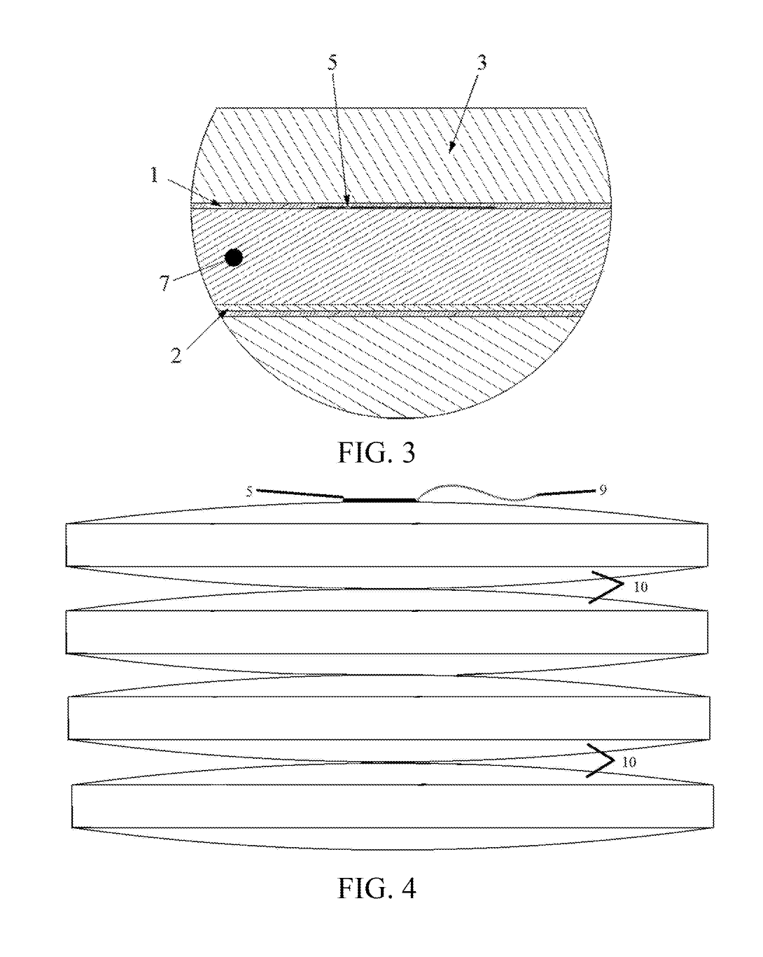

Referring to FIG. 2 and FIG. 3, a safety structure of a power battery pack is provided. The battery pack may include several single electrochemical cells. The safety structure may include an expansion absorption layer 1, a supporting and fixing tray 2, an upper module press plate 3, and a lower module bottom plate 4. There are multiple supporting and fixing trays 2 and multiple expansion absorption layers 1. The multiple supporting and fixing trays 2 are sequentially disposed from top to bottom layer by layer in the form of a stack. One single electrochemical cell may be disposed in each of the supporting and fixing trays 2. One expansion absorption layer 1 may be laid on a top surface of each single electrochemical cell. The upper module press plate 3 may be disposed in a manner of covering the topmost supporting and fixing tray 2. The lower module bottom plate 4 may be disposed on a bottom surface of the bottommost supporting and fixing tray 2. A strain sensor 5 may be attached to the center of a top surface of the topmost single electrochemical cell, so as to ensure that the position of the strain sensor 5 does not change due to expansion of the electrochemical cell. The strain sensor 5 may be connected to a BMS control board by using a signal cable 9. A single electrochemical cell in FIG. 1 may be a pouch electrochemical cell 7.

As shown in FIG. 4, when the topmost single electrochemical cell expands, or a lower layer single electrochemical cell expands to push the topmost single electrochemical cell upwards, the strain sensor 5 changes a resistance value of the strain sensor 5, and a BMS detects the resistance value change. The BMS control board receives strain information collected by the strain sensor 5. The strain information reflects an expansion and deformation degree of an electrochemical cell. The BMS control board monitors, in real time, a health status, a lifetime status, and extreme cases of electric shortage, overcharging, and the like by detecting expansion and deformation of the electrochemical cell, and this exerts an obvious advantage over an early diagnosis and improvement of a power battery safety problem, and further has a unique advantage over personnel evacuation before a crisis occurs and alarm giving. Therefore, high safety of a power battery pack is implemented.

The safety structure further may include a module supporting member 6. A supporting member through hole may be disposed on each of the supporting and fixing trays 2. A supporting member fixing hole may be disposed on each of the upper module press plate 3 and the lower module bottom plate 4. Two ends of the module supporting member 6 are respectively fixed in the supporting member fixing holes of the upper module press plate 3 and the lower module bottom plate 4 after the module supporting member 6 passes through the supporting member through holes of the supporting and fixing trays 2.

There are multiple module supporting members 6. The module supporting members 6 being two in this embodiment is used for illustration only. An actual quantity is designed according to a specific situation. A built-in bolt of the module supporting member 6 may be a step bolt, so as to determine, during tightening, relative positions of the upper module press plate 3 and the lower module bottom plate 4.

The stiffness of the lower module bottom plate 4 may be higher than the stiffness of the upper module press plate (3) and the stiffness of the supporting and fixing tray 2, so that expansion is transferred upwards. An upper module covering plate selects proper stiffness according to pre-pressure and expansion performance that are needed by the pouch electrochemical cell 7.

The expansion absorption layer 1 may be made of foamed plastic. The expansion absorption layer 1 has certain elasticity, and can bear expansion and deformation of a single electrochemical cell within a certain range.

A surface of the strain sensor 5 may be coated with a thermal insulation protection film, so that the reliability of the strain sensor 5 may be better ensured. The strain sensor 5 may be a resistive strain sensor, which has low manufacturing costs, and is easy to implement.

The quantity of single electrochemical cells may be greater than 1 and less than or equal to 30. In FIG. 1, 14 pouch electrochemical cells 7 are used, so as to ensure safety of a high-capacity power battery pack. As the quantity of superimposition layers increases, an error of detecting an expansion status of a remote electrochemical cell by the strain sensor also increases accordingly.

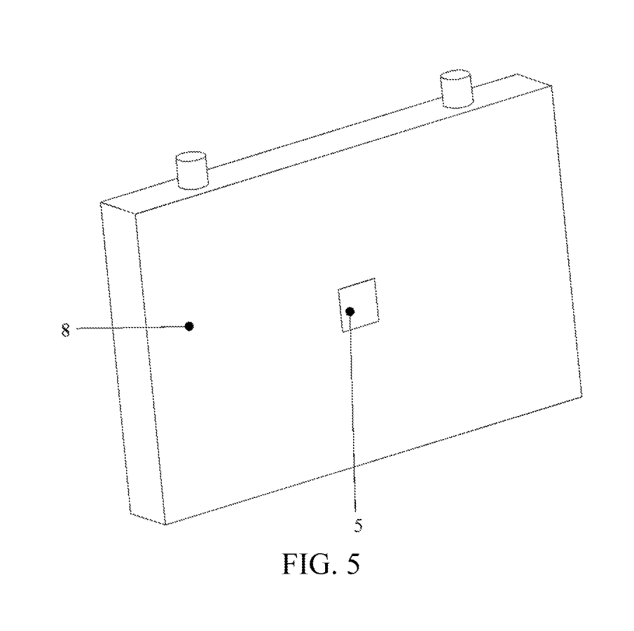

As shown in FIG. 5, the single electrochemical cell may also be a hard shelled electrochemical cell 8. The strain sensor 5 may be attached to the center of the largest surface of an electrochemical cell on an outermost side. For matters of a module design of the hard-shelled electrochemical cell 8 that need attention, refer to a safety structure design of a module of the pouch electrochemical cell 7.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A safety structure of a power battery pack, wherein the battery pack comprises a plurality of single electrochemical cells, the safety structure comprises:
a plurality of supporting and fixing trays;
a plurality of expansion absorption layers;
the plurality of supporting and fixing trays are disposed as a stack;
one single electrochemical cell of a plurality of single electrochemical cells is disposed in each of the supporting and fixing trays of the stack;
one expansion absorption layer is disposed on a top surface of each single electrochemical cell;
an upper module press plate, wherein the upper module press plate is disposed to cover a topmost supporting and fixing tray of the stack;
a lower module bottom plate is disposed on a lower side of a bottommost supporting and fixing tray of the stack;
a strain sensor disposed substantially in a center of a top surface of a topmost single electrochemical cell, wherein the strain sensor is located between the topmost single electrochemical cell and the upper module press plate, wherein expansion of at least one of the plurality of single electrochemical cells causes the strain sensor to be pressed between the topmost single electrochemical cell and the upper module press plate; and
the strain sensor being in communication with a battery management system.

2. The safety structure of a power battery pack according to claim 1, wherein the safety structure further comprises:
a module supporting member;
a supporting member through hole is disposed on each of the supporting and fixing trays;
a supporting member fixing hole is disposed on each of the upper module press plate and the lower module bottom plate; and
two ends of the module supporting member are respectively fixed in the supporting member fixing holes of the upper module press plate and the lower module bottom plate after the module supporting member passes through the supporting member through holes of the supporting and fixing trays.

3. The safety structure of a power battery pack according to claim 2, wherein the module supporting member comprises a plurality of module supporting members.

4. The safety structure of a power battery pack according to claim 1, wherein a stiffness of the lower module bottom plate is higher than a stiffness of both the upper module press plate and the stiffness of the supporting and fixing tray.

5. The safety structure of a power battery pack according to claim 1, wherein each of the expansion absorption layers of the plurality of expansion absorption layers is made of foamed silicone rubber.

6. The safety structure of a power battery pack according to claim 1, wherein the strain sensor is attached to a center of the top surface of the topmost single electrochemical cell.

7. The safety structure of a power battery pack according to claim 1, wherein a surface of the strain sensor is coated with a thermal insulation protection film.

8. The safety structure of a power battery pack according to claim 1, wherein the strain sensor is a resistive strain sensor.

9. The safety structure of a power battery pack according to claim 1, comprising single electrochemical cells in a quantity greater than 1 and less than or equal to 30.

10. The safety structure of a power battery pack according to claim 1, wherein the single electrochemical cell is a pouch electrochemical cell.
